(19) United States
(12) Patent Application Publication
(10) Pub. No.: US 2014/0369557 A1
(43) Pub. Date: Dec. 18, 2014

(54) Systems and Methods for Feature-Based Tracking

(71) Applicant: QUALCOMM Incorporated, San Diego, CA (US)

(72) Inventors: Guy-Richard Kayombya, San Diego, CA (US); Seyed Hesameddin Najafi Shoushtari, San Diego, CA (US); Dheeraj Ahuja, San Diego, CA (US); Yanghai Tsin, Palo Alto, CA (US)

(73) Assignee: QUALCOMM Incorporated, San Diego, CA (US)

(21) Appl. No.: 14/263,866

(22) Filed: Apr. 28, 2014

Related U.S. Application Data
(60) Provisional application No. 61/835,378, filed on Jun. 14, 2013.

(51) Int. Cl. G06K 9/00

(52) U.S. Cl. CPC G06K 9/00624
USPC 382/103

(57) ABSTRACT

Disclosed embodiments pertain to feature based tracking. In some embodiments, a camera pose may be obtained relative to a tracked object in a first image and a predicted camera pose relative to the tracked object may be determined for a second image subsequent to the first image based, in part, on a motion model of the tracked object. An updated SE(3) camera pose may then be obtained based, in part on the predicted camera pose, by estimating a plane induced homography using an equation of a dominant plane of the tracked object, wherein the plane induced homography is used to align a first lower resolution version of the first image and a first lower resolution version of the second image by minimizing the sum of their squared intensity differences. A feature tracker may be initialized with the updated SE(3) camera pose.

### CROSS REFERENCE TO RELATED APPLICATIONS

This application claims the benefit of and priority to U.S. Provisional Application No. 61/835,378 entitled “Systems And Methods for Feature-Based Tracking,” filed Jun. 14, 2013, which is assigned to the assignee hereof and incorporated by reference, in its entirety, herein.

### FIELD

This disclosure relates generally to apparatus, systems, and methods for feature based tracking, and in particular, to feature-based tracking using image alignment motion initialization.

### BACKGROUND

In computer vision, 3-dimensional (“3D”) reconstruction is the process of determining the shape and/or appearance of real objects and/or the environment. In general, the term 3D model is used herein to refer to a representation of a 3D environment being modeled by a device. 3D reconstruction may be based on data and/or images of an object obtained from various types of sensors including cameras.

Augmented Reality (AR) applications are often used in conjunction with 3D reconstruction. In AR applications, which may be real-time interactive, real world images may be processed to add virtual object(s) to the image and to align the virtual object to a captured image in 3-D. Therefore, identifying objects present in a real image as well as determining the location and orientation of those objects may facilitate effective operation of many AR systems and may be used to aid virtual object placement.

In AR, detection refers to the process of localizing a target object in a captured image frame and computing a camera pose with respect to the object. Tracking refers to camera pose estimation relative to the object over a temporal sequence of image frames. In feature-based tracking, 3D model features may be matched with features in a current image to estimate camera pose. For example, feature-based tracking may compare a current and prior image and/or the current image with one or more registered reference images to update and/or estimate camera pose.

However, there are several situations where feature based tracking may not perform adequately. For example, tracking performance may be degraded when a camera is moved rapidly producing large unpredictable motion. In general, camera or object movements during a period of camera exposure can result in motion blur. For handheld cameras motion blur may occur because of hand jitter and may be exacerbated by long exposure times due to non-optimal lighting conditions. The resultant blurring can make the tracking of features difficult. In general, feature-based tracking methods may suffer from inaccuracies that may result in poor pose estimation in the presence of motion blur, in case of fast camera acceleration, and/or in case of oblique camera angles.

### SUMMARY

Disclosed embodiments pertain to systems, methods and apparatus for effecting feature-based tracking using image alignment and motion initialization.

In some embodiments, a method may comprise obtaining a camera pose relative to a tracked object in a first image and determining a predicted camera pose relative to the tracked object for a second image subsequent to the first image based, in part, on a motion model of the tracked object. An updated Special Euclidean Group (3) (SE(3)) camera pose may be obtained based, in part on the predicted camera pose, by estimating a plane induced homography using an equation of a dominant plane of the tracked object, wherein the plane induced homography is used to align a first lower resolution version of the first image and a first lower resolution version of the second image by minimizing the sum of the squared intensity differences of the first lower resolution version of the first image and the first lower resolution version of the second image.

In another aspect, disclosed embodiments pertain to a Mobile Station (MS) comprising: a camera, the camera to capture a first image and a second image subsequent to the first image, and a processor coupled to the camera. In some embodiments, the processor may be configured to: obtain a camera pose relative to a tracked object in the first image, and determine a predicted camera pose relative to the tracked object for the second image based, in part, on a motion model of the tracked object. The processor may be further configured to obtain an updated Special Euclidean Group (3) (SE(3)) camera pose, based, in part on the predicted camera pose, by estimating a plane induced homography using an equation of a dominant plane of the tracked object, wherein the plane induced homography is used to align a first lower resolution version of the first image and a first lower resolution version of the second image by minimizing the sum of the squared intensity differences first lower resolution version of the first image and the first lower resolution version of the second image.

Additional embodiments pertain to an apparatus comprising: imaging means, the imaging means to capture a first image and a second image subsequent to the first image; means for obtaining a imaging means pose relative to a tracked object in the first image, means for determining a predicted imaging means pose relative to the tracked object for the second image based, in part, on a motion model of the tracked object; and means for obtaining an updated Special Euclidean Group (3) (SE(3)) imaging means pose, based, in part on the predicted imaging means pose, by estimating a plane induced homography using an equation of a dominant plane of the tracked object, wherein the plane induced homography is used to align a first lower resolution version of the first image and a first lower resolution version of the second image by minimizing the sum of the squared intensity differences of the first lower resolution version of the first image and the first lower resolution version of the second image.

In another embodiment, a non-transitory computer-readable medium is disclosed. The computer-readable medium may comprise instructions, which, when executed by a processor, perform steps in a method, wherein the steps may comprise: obtaining a camera pose relative to a tracked object in a first image; determining a predicted camera pose relative to the tracked object for a second image subsequent to the first image based, in part, on a motion model of the tracked object; and obtaining an updated Special Euclidean Group (3) (SE(3)) camera pose, based, in part on the predicted camera pose, by estimating a plane induced homography using an equation of a dominant plane of the tracked object, wherein the plane induced homography is used to align a first lower resolution version of the first image and a first lower resolution version of the second image by minimizing the sum of the squared intensity differences first lower resolution version of the first image and the first lower resolution version of the second image.

### BRIEF DESCRIPTION OF THE DRAWINGS

Embodiments of the invention will be described, by way of example only, with reference to the drawings.

FIG. 1 shows a block diagram of an exemplary user device capable of implementing feature based tracking in a manner consistent with disclosed embodiments.

FIG. 2 shows a diagram illustrating functional blocks in feature tracking system consistent with disclosed embodiments.

FIGS. 3A and 3B show a flowchart for an exemplary method for feature based tracking in a manner consistent with disclosed embodiments.

FIG. 4 shows a flowchart for an exemplary method for feature based tracking in a manner consistent with disclosed embodiments.

FIG. 5A shows a chart illustrating the initial tracking performance for a feature rich target with both point and line features for two Natural Features Tracking (NFT) methods shown as NFT-4 without image alignment and NFT4 with image alignment.

FIG. 5B shows a table with performance comparisons showing tracking results for four different target types.

FIG. 6 shows a schematic block diagram illustrating a computing device enabled to facilitate feature based tracking in a manner consistent with disclosed embodiments.

### DETAILED DESCRIPTION

In feature-based visual tracking, local features are tracked across an image sequence. However, there are several situations where feature based tracking may not perform adequately. Feature-based tracking methods may not reliably estimate camera pose and/or track objects in the presence of motion blur, in case of fast camera acceleration, and/or in case of oblique camera angles. Conventional approaches to reliably track objects have used motion models such as linear motion prediction or double exponential smoothing facilitate tracking. However, such motion models are approximations and may not reliably track objects when the models do not accurately reflect the movement of the tracked object.

Other conventional approaches have used sensor fusion, where measurements from gyroscopes and accelerometers are used in conjunction with motion prediction to improve tracking reliability. A sensor based approach is limited to devices that possess the requisite sensors. In addition, the accumulation of accelerometer drift and biasing errors may affect tracking reliability over time. In another approach, fast image alignment in SE(2) has been used for tracking, which assumes that the tracking target lies on a plane parallel to the image plane. In general, the notation SE(n) refers to a Special Euclidean Group, which represent isometries that preserve orientation also called rigid motions. Isometries are distance-preserving mappings between metric spaces. Rigid motions include translations and rotations, which together determine “n”. The number of Degrees Of Freedom (DoF) for SE(n) in given by n(n+1)/2, so that there are 3 DoF for SE(2). The SE(2) approach can only estimate 2D translation and rotation in the image plane and may produce erroneous and/or inaccurate pose estimates at oblique camera angles.

Therefore, some embodiments disclosed herein apply computer vision and other image processing techniques to improve the accuracy of pose estimation and enhance accuracy in feature-based tracking approaches to achieve a more optimal user experience.

These and other embodiments are further explained below with respect to the following figures. It is understood that other aspects will become readily apparent to those skilled in the art from the following detailed description, wherein various aspects are shown and described by way of illustration. The drawings and detailed description are to be regarded as illustrative in nature and not as restrictive.

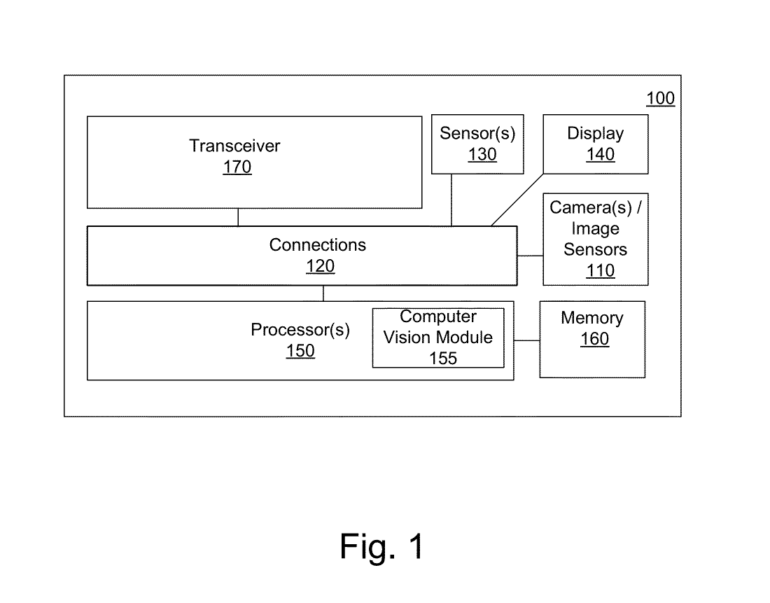

FIG. 1 shows a block diagram of User Device (UD) 100, which may take the form of an exemplary user device and/or other user equipment capable of running AR applications. In some embodiments, UD 100 may be capable of implementing AR methods based on an existing model of a 3D environment. In some embodiments, the AR methods may be implemented in real time or near real time in a manner consistent with disclosed embodiments.

As used herein, UD 100, may take the form of a cellular phone, mobile phone, or other wireless communication device, a personal communication system (PCS) device, personal navigation device (PND), Personal Information Manager (PIM), or a Personal Digital Assistant (PDA), a laptop, tablet, notebook and/or handheld computer or other mobile device. In some embodiments, UD 100 may be capable of receiving wireless communication and/or navigation signals.

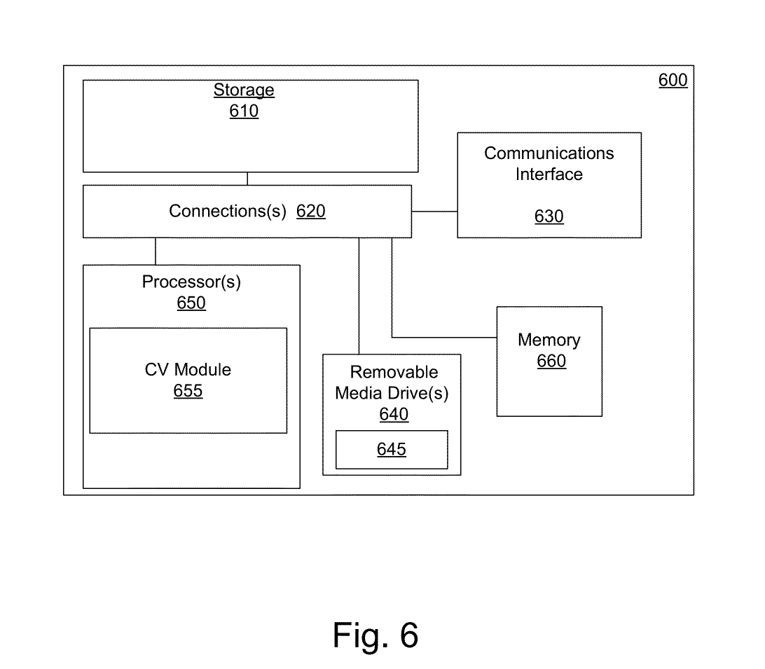

Further, the term “user device” is also intended to include devices which communicate with a personal navigation device (PND), such as by short-range wireless, infrared, wireline connection, or other connections and/or position-related processing occurs at the device or at the PND. Also, “user device” is intended to include all devices, including various wireless communication devices, which are capable of communication with a server (such computing device 600 in FIG. 6, which may take the form of a server), regardless of whether wireless signal reception, assistance data reception, and/or related processing occurs at the device, at a server, or at another device associated with the network. Any operable combination of the above are also considered a “user device.”

The term user device is also intended to include gaming or other devices that may not be configured to connect to a network or to otherwise communicate, either wirelessly or over a wired connection, with another device. For example, a user device may omit communication elements and/or networking functionality. For example, embodiments described herein may be implemented in a standalone device that is not configured to connect for wired or wireless networking with another device.

As shown in FIG. 1, UD 100 may include camera(s) or image sensors 110 (hereinafter referred to as “camera(s) 110”), sensor bank or sensors 130, display 140, one or more processors 150 (hereinafter referred to as “processor(s) 150”), memory 160 and/or transceiver 170, which may be operatively coupled to each other and to other functional units (not shown) on UD 100 through connections 120. Connections 120 may comprise buses, lines, fibers, links, etc., or some combination thereof.

Transceiver 170 may, for example, include a transmitter enabled to transmit one or more signals over one or more types of wireless communication networks and a receiver to receive one or more signals transmitted over the one or more types of wireless communication networks. Transceiver 170 may facilitate communication with wireless networks based on a variety of technologies such as, but not limited to, femtocells, Wi-Fi networks or Wireless Local Area Networks (WLANs), which may be based on the IEEE 802.11 family of standards, Wireless Personal Area Networks (WPANS) such Bluetooth, Near Field Communication (NFC), networks based on the IEEE 802.15x family of standards, etc, and/or Wireless Wide Area Networks (WWANs) such as LTE, WiMAX, etc.

For example, the transceiver 170 may facilitate communication with a WWAN such as a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), WiMax and so on.

A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM, W-CDMA, and LTE are described in documents from an organization known as the “3rd Generation Partnership Project” (3GPP). Cdma2000 is described in documents from a consortium named “3rd Generation Partnership Project 2” (3GPP2). 3GPP and 3GPP2 documents are publicly available. The techniques may also be implemented in conjunction with any combination of WWAN, WLAN and/or WPAN. User device may also include one or more ports for communicating over wired networks.

In some embodiments, camera(s) 110 may include multiple cameras, front and/or rear-facing cameras, wide-angle cameras, and may also incorporate CCD, CMOS, and/or other sensors. Camera(s) 110, which may be still or video cameras, may capture a series of image frames, such as video images, of an environment and send the captured video/image frames to processor(s) 150. The images captured by camera(s) 110 may be color (e.g. in Red-Green-Blue (RGB)) or grayscale. In one embodiment, images captured by camera(s) 110 may be in a raw uncompressed format and may be compressed prior to being processed and/or stored in memory 160. In some embodiments, image compression may be performed by processor(s) 150 using lossless or lossy compression techniques. In some embodiments, camera(s) 110 may be stereoscopic cameras capable of capturing 3D images. In another embodiment, camera(s) 110 may include depth sensors that are capable of estimating depth information. For example, MS 100 may comprise RGBD cameras, which may capture per-pixel depth information when the depth sensor is enabled, in addition to color (RGB) images. As another example, in some embodiments, camera(s) 110 may take the form of a 3D Time Of Flight (3DTOF) camera. In embodiments with 3DTOF camera(s) 110, the depth sensor may take the form of a strobe light coupled to the 3DTOF camera, which may illuminate objects in a scene and reflected light may be captured by a CCD/CMOS or other image sensors. Depth information may be obtained by measuring the time that the light pulses take to travel to the objects and back to the sensor.

Processor(s) 150 may also execute software to process image frames received from camera(s) 110. For example, processor(s) 150 may be capable of processing one or more image frames received from a camera 110 to determine the pose of camera 110 and/or to perform 3D reconstruction of an environment corresponding to an image captured by camera 110. The pose of camera 110 refers to the position and orientation of the camera 110 relative to a frame of reference. In some embodiments, camera pose may be determined for 6-Degrees Of Freedom (6DOF), which refers to three translation components (which may be given by X,Y,Z coordinates) and three angular components (e.g. roll, pitch and yaw). In some embodiments, the pose of camera 110 and/or UD 100 may be determined and/or tracked by processor(s) 150 using a visual tracking solution based on image frames captured by camera 110.

Processor(s) 150 may be implemented using a combination of hardware, firmware, and software. Processor(s) 150 may represent one or more circuits configurable to perform at least a portion of a computing procedure or process related to 3D reconstruction, Simultaneous Localization And Mapping (SLAM), tracking, modeling, image processing etc and may retrieve instructions and/or data from memory 160. Processors 150 may be implemented using one or more application specific integrated circuits (ASICs), central and/or graphical processing units (CPUs and/or GPUs), digital signal processors (DSPs), digital signal processing devices (DSPDs), programmable logic devices (PLDs), field programmable gate arrays (FPGAs), controllers, micro-controllers, microprocessors, embedded processor cores, electronic devices, other electronic units designed to perform the functions described herein, or a combination thereof. In some embodiments, processor(s) 150 may may be implemented using dedicated circuitry, such as Application Specific Integrated Circuits (ASICs), Digital Signal Processors (DSPs), and/or dedicated processor (such as processing unit(s) 150).

In some embodiments, processor(s) 150 may comprise Computer Vision Module (CVM) 155. The term “module” as used herein may refer to a hardware, firmware and/or software implementation. For example, CVM 155 may be implemented using hardware, firmware, software or a combination thereof. CVM 155 may implement various computer vision and/or image processing methods such as 3D reconstruction, image compression and filtering. CVM 155 may also implement computer vision based tracking, model-based tracking, SLAM, etc. In some embodiments, the methods implemented by CVM 155 may be based on color or grayscale image data captured by camera(s) 110, which may be used to generate estimates of 6-DOF pose measurements of the camera.

SLAM refers to a class of techniques where a map of an environment, such as a map of an environment being modeled by UD 100, is created while simultaneously tracking the pose of UD 100 relative to that map. SLAM techniques include Visual SLAM (VLSAM), where images captured by a camera, such as camera(s) 110 on UD 100, may be used to create a map of an environment while simultaneously tracking the camera's pose relative to that map. VSLAM may thus involve tracking the 6DOF pose of a camera while also determining the 3-D structure of the surrounding environment. For example, in some embodiments, VSLAM techniques may detect salient feature patches in one or more captured image frames and store the captured imaged frames as keyframes or reference frames. In keyframe based SLAM, the pose of the camera may then be determined, for example, by comparing a currently captured image frame with one or more previously captured and/or stored keyframes.

In some embodiments, processor(s) 150 and/or CVM 155 may be capable of executing various AR applications, which may use visual feature based tracking. In one embodiment, processor(s) 150/CVM 155 may track the position of camera(s) 180 by using monocular VSLAM techniques to build a coarse map of the environment around MS 100 for accurate and robust 6DOF tracking of camera(s) 110. The term monocular refers to the use of a single non stereoscopic camera to capture images or to images captured without depth information.

Memory 160 may be implemented within processor(s) 150 and/or external to processor(s) 150. As used herein the term “memory” refers to any type of long term, short term, volatile, nonvolatile, or other memory and is not to be limited to any particular type of memory or number of memories, or type of physical media upon which memory is stored. In some embodiments, memory 160 may hold code to facilitate image processing, perform tracking, modeling, 3D reconstruction, and other tasks performed by processor(s) 150. For example, memory 160 may hold data, captured still images, 3D models, depth information, video frames, program results, as well as data provided by various sensors. In general, memory 160 may represent any data storage mechanism. Memory 160 may include, for example, a primary memory and/or a secondary memory. Primary memory may include, for example, a random access memory, read only memory, etc. While illustrated in FIG. 1 as being separate from processor(s) 150, it should be understood that all or part of a primary memory may be provided within or otherwise co-located and/or coupled to processor(s) 150.

Secondary memory may include, for example, the same or similar type of memory as primary memory and/or one or more data storage devices or systems, such as, for example, flash/USB memory drives, memory card drives, disk drives, optical disc drives, tape drives, solid state drives, hybrid drives etc. In certain implementations, secondary memory may be operatively receptive of, or otherwise configurable to couple to a non-transitory computer-readable medium in a removable media drive (not shown) coupled to user device 100. In some embodiments, non-transitory computer readable medium may form part of memory 160 and/or processor(s) 150.

UD 100 may also include sensors 130, which, in certain example implementations, UD 100 may include an Inertial Measurement Unit (IMU), which may comprise 3 axis accelerometer(s), 3-axis gyroscope(s), and/or magnetometer(s), may provide velocity, orientation, and/or other position related information to processor(s) 150. In some embodiments, IMU may output measured information in synchronization with the capture of each image frame by camera(s) 110. In some embodiments, the output of IMU may be used in part by processor(s) 150 to determine, correct, and/or otherwise adjust the estimated pose a pose of camera 110 and/or UD 100. Further, in some embodiments, images captured by camera(s) 110 may also be used to recalibrate or perform bias adjustments for the IMU. In some embodiments, UD 100 may comprise a variety of other sensors, such as ambient light sensors, microphones, acoustic sensors, ultrasonic sensors, laser range finders, etc. In some embodiments, portions of UD 100 may take the form of one or more chipsets, and/or the like.

Further, UD 100 may include a screen or display 140 capable of rendering color images, including 3D images. In some embodiments, display 180 may be used to display live images captured by camera 110, Augmented Reality (AR) images, Graphical User Interfaces (GUIs), program output, etc. In some embodiments, display 140 may comprise and/or be housed with a touchscreen to permit users to input data via some combination of virtual keyboards, icons, menus, or other GUIs, user gestures and/or input devices such as a stylus and other input devices. In some embodiments, display 140 may be implemented using a Liquid Crystal Display (LCD) display or a Light Emitting Diode (LED) display, such as an Organic LED (OLED) display. In other embodiments, display 140 may be a wearable display, which may be operationally coupled to, but housed separately from, other functional units in UD 100. In some embodiments, UD 100 may comprise ports to permit the display of images through a separate monitor coupled to MS 100.

Not all modules comprised in UD 100 have been shown in FIG. 1. Exemplary UD 100 may also be modified in various ways in a manner consistent with the disclosure, such as, by adding, combining, or omitting one or more of the functional blocks shown. For example, in some configurations, UD 100 may not include transceiver 170 and/or one or more sensors 130. In some embodiments, UD 100 may comprise a Position Location System. A position location system may comprise some combination of a Satellite Positioning System (SPS), Terrestrial Positioning System, Bluetooth positioning, Wi-Fi positioning, cellular positioning, etc. The Position Location System may be used to provide location information to UD 100.

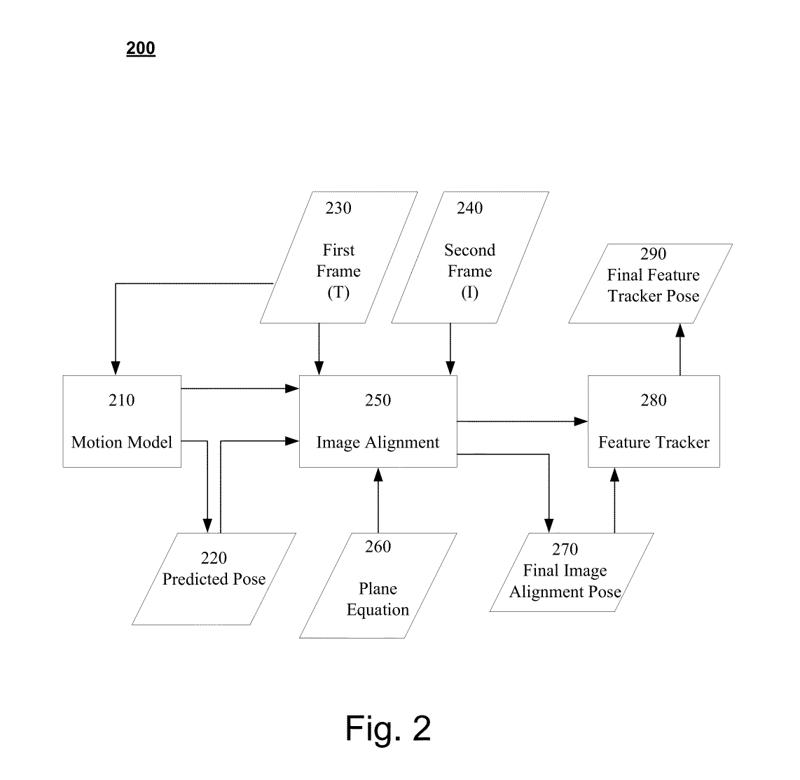

FIG. 2 shows a diagram illustrating functional blocks in a feature tracking system 200 consistent with disclosed embodiments. In some embodiments, the feature tracking system 200 may comprise motion model 210, image alignment module 250, and feature tracker 280. In some embodiments, the feature tracking system 200 may receive first frame 230, second frame 240 and plane equation 260 as input. For example, second frame 240 and first frame 230 may be a current image frame and a recent prior image frame, respectively. First frame 230, in some instances, may be an image frame that immediately precedes second frame 240 captured by camera 110. In some embodiments, first frame 230 and second frame 240 may be consecutive image frames.

In some embodiments, motion model 210 may be used to predict inter-frame camera motion, which may be used to estimate predicted pose 220. The term inter-frame camera motion refers to motion of camera 110 relative to a tracked object in the time interval between the capture of first fame 230 and second frame 240. In some embodiments, predictions of future camera motion relative to tracked features using motion model 210 may be based on a history of data. For example, for a translational model of motion, inter-frame camera motion may be predicted by assuming a constant camera velocity. Thus, motion model 210 may provide a temporal variation of translation matrices that may be used to estimate the location of tracked features in future frames. In some embodiments, motion model 210, which may comprise temporal variations of translation matrices, may be applied to first frame 230. Accordingly, for example, the features in second frame 240 may be searched based on their motion model 210 estimated location and used to determine predicted pose 220.

In some embodiments, the image alignment module block 250 may receive the predicted pose 220 computed in the motion model 210, the plane equation 260, the first frame 230, and the second frame 240 as input. In some embodiments, a prior 3D Model of the target may be used in conjunction with the predicted pose 220 to compute a dominant plane and obtain the plane equation 260 for the dominant plane. In general, the term “dominant plane” refers to the plane that closely or best approximates the 3D surface of the target currently in view of the camera.

Various techniques may be used to compute the plane equation 260 for a dominant plane from a 3D Model. For example, in some embodiments, a dominant plane equation 260 may be computed in world coordinates and the techniques selected may correspond to the nature of the target. The term“world coordinates” refers to points described relative to a fixed coordinate center in the real world. In some embodiments, the 3D Model may take the form of a Computer Aided Design (CAD) model. As another example, for a planar target, the target may be assumed to lie on the z-plane with coordinates (0, 0, 1, 0). For a conical target, the equation of a plane that is tangent to the cone and directly in front of the camera may be used as the equation of the dominant plane.

In some embodiments, for 3D targets, a set of N key frames from which 3D features are extracted may be used. Further, for each key frame in the set of N frames, a geometric least square plane may be fitted to the extracted 3D features to obtain the dominant plane. In some embodiments, the set of keyframes may be obtained from images captured by a camera (such as camera(s) 110).

In some embodiments, each keyframe may also be associated with a camera-centered coordinate frame, and may comprise a pyramid of images of different resolutions. For example, a keyframe may be subsampled to obtain a pyramid of images of differing resolutions that are associated with the keyframe. The pyramid of images may be obtained iteratively, or, in parallel. In one implementation, the highest level (level 0) of the pyramid may have the raw or highest resolution image and each level below may downsample the image relative to the level immediately above by some factor. For example, for an image I₀ of size 640×480 (at level 0), the images h, I₂, I₃, I₄ and I₅ are of sizes 320×240, 160×120, 80×60, 40×30, and 20×15, respectively, where the subscript indicates the image level in the image pyramid.

Further, each feature point in the keyframe may be associated with: (i) its source keyframe, (ii) one of the subsampled images associated with the keyframe and (iii) a pixel location within the subsampled image. Each feature point may also be associated with a patch or template. A patch refers to a portion of the (subsampled) image corresponding to a region around a feature point in the (subsampled) image. In some embodiments, the region may take the form of a polygon. In some embodiments, the keyframes may be used by a feature tracker for pose estimation.

Further, in some embodiments, image alignment module 250 may use predicted pose 220 to determine a translational displacement (x,y) between first frame 230 and second frame 240 that maximizes the Normalized Cross Correlation (NCC) between downsampled and/or blurred versions of first frame 230 and second frame 240. For example, image alignment module block 250 may use predicted pose 220 to determine the positions of feature points in second frame 240 and compute a translational displacement (x,y) between first frame 230 and second frame 240 that maximizes the Normalized Cross Correlation (NCC) between downsampled and/or blurred versions of first frame 230 and second frame 240. In some embodiments, the downsampled versions may represent coarse or lower resolution versions of first frame 230 and second frame 240. Blurring may be implemented using a 3×3 Gaussian filter. In one embodiment, for example, the NCC may be estimated at a coarse level of the image pyramid using downsampled images with a resolution of 20×15 pixels, which may be at level 5 of the image pyramid. In some embodiments, the translational displacement may be used to compute a two dimensional (2D) translational pose update.

In some embodiments, image alignment block 250 may then use plane equation 260 and/or the NCC derived translational 2D pose update to iteratively refine the NCC derived translational 2D pose to obtain final image alignment pose 270 by estimating the plane induced homography that aligns the two consecutive frames at a finer (higher resolution) levels of the image pyramid so as to minimize the sum of their squared intensity differences using an efficient optimization algorithm. For example, the result computed at the lowest pyramid level L is propagated to the upper level L-1 in a form of a translational 2D pose update estimate at level L-1. Given that estimate, the refined optical flow is computed at level L-1, and the result is propagated to level L-2 and so on up to the level 0 (the original image).

In some embodiments, an efficient Lucas-Kanade or an equivalent algorithm may be used to determine final image alignment pose 270 by iteratively computing pose updates and corresponding homography matrices until convergence. In some embodiments, a Jacobian matrix representing a matrix of all first-order partial derivatives of the plane induced homography function with respect to pose may be derived from the plane equation 260 and used in the iterative computation of pose updates. In some embodiments, an Inverse Compositional Image Alignment technique, which is functionally equivalent to the Lucas-Kanade algorithm but more efficient computationally, may be used to determine final image alignment pose 270. The Inverse Compositional Image Alignment technique minimizes

Σₓ[T(W(x;Δp))−I(W(x;p))]² (1)

with respect to Δp, where:

T is first image frame 230,

I is second image frame 240,

W is a plane induced homography

p is the current pose estimate, and

Δp is the incremental pose.

In some embodiments, final image alignment pose 270 may be input to feature tracker block 280, which may use final image alignment pose 270 to compute a final feature tracker pose using the 3D model.

In some embodiments, method 200 may be performed by processor(s) 150 on UD 100 using image frames captured by camera(s) 110 and/or stored in memory 160. In some embodiments, method 200 may be performed by processors 150 in conjunction with one or more other functional units on UD 100.

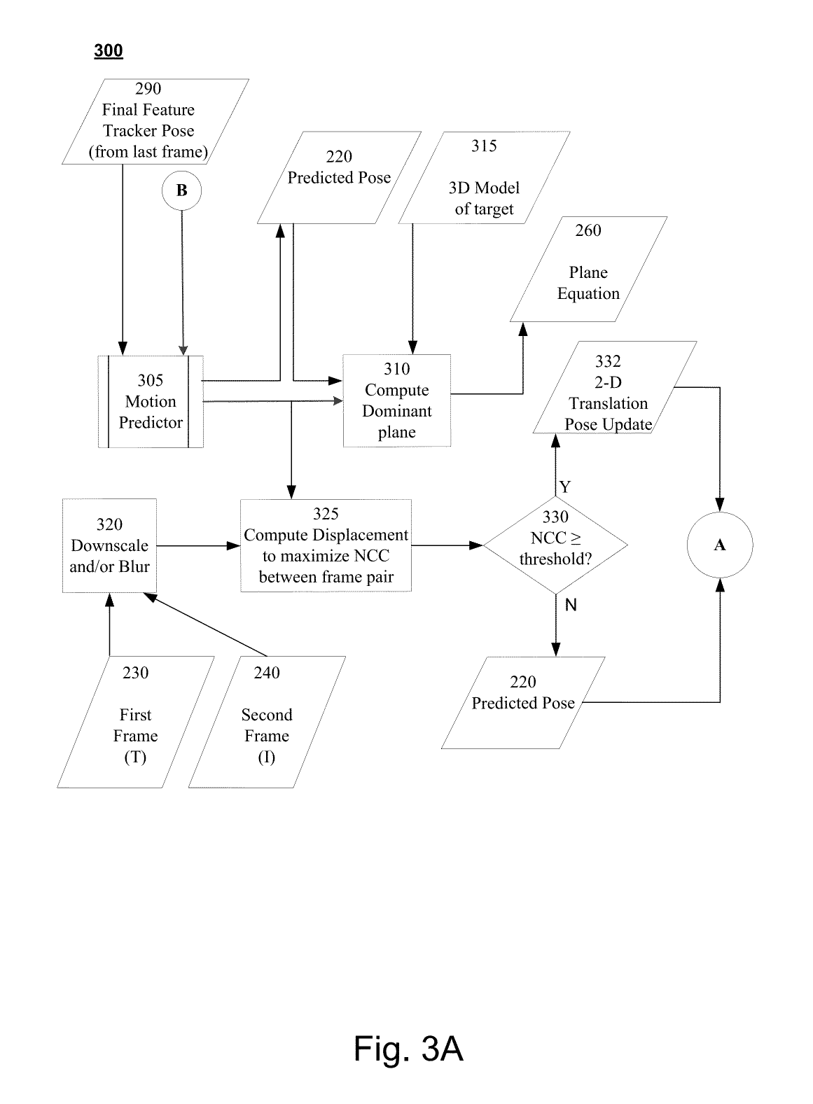

FIGS. 3A and 3B show a flowchart for an exemplary method 300 for feature based tracking in a manner consistent with disclosed embodiments. In some embodiments, method 300 may use image alignment for motion initialization of a feature based tracker. In some embodiments, method 300 may be performed on user device 100.

Motion predictor module/step 305 may use a motion model, such as motion model 210, and a computed feature tracker pose 290 from first frame 230 to predict inter-frame camera motion. For example, the motion predictor module 305 may predict inter-frame camera motion for the second frame 240 and obtain the predicted pose 220 based on the motion model 210 and the computed feature tracker pose 290 from the first frame 230, which may be an immediately preceding frame. In some embodiments, predictions of future camera motion relative to tracked features using the motion model 210 may be based on the camera motion history. For example, for a translational model of motion, inter-frame camera motion may be predicted by assuming a constant camera velocity between frames. Thus, the motion model 210 may provide a temporal variation of translation matrices that may be used to estimate the location of tracked features in the second frame 240. The motion predictor module 305 may use the computed feature tracker pose 290 from the first frame 230 and a motion model based estimate of relative camera motion to determine the predicted pose 220.

In step 310, the plane equation 260 for the dominant plane may be computed based, in part, on a pre-existing 3D model of the target 315. In some embodiments, a prior 3D Model of the target 315 may be used in conjunction with the predicted pose 220 to compute a dominant plane and obtain the plane equation 260. In another embodiment, the techniques disclosed may be applied in conjunction with the real-time creation of a 3D model of the target 315.

In some embodiments, the dominant plane equation may be computed relative to a world coordinate system “w”. In the world coordinate system, the plane equation may be defined by n_{w} and d_{w} where n_{w} is the equation of a vector normal to the plane and d_{w} is the distance from the origin such that a 3D point X on the plane has the property

n_{w}^{T}·X+d_{w}=0 (2)

If the template image T corresponds to a pose [R|t], then, the plane equation in the camera coordinate system may be given by [n,d] where

n=R·n_{w} (3)

and

d=d_{w}−t^{T}·R·n_{w}. (4)

In step 320, first frame 230, and second frame 240 may be received as input. In some embodiments, first frame 230, and second frame 240 may be consecutive image frames. In step 320, first frame 230, and second frame 240 may be downsampled. In some embodiments, first frame 230, and second frame 240 may be downsampled to obtain a pyramid of images of different resolutions of first frame 230 and a pyramid of images of different resolutions of second frame 240. In one embodiment, each level of the image pyramid may be half the resolution of the level above. The number of levels of the image pyramid may be varied. In some embodiments, the images may be downsampled until a threshold resolution is reached. Accordingly, for an image at an original resolution (raw image) of 640×480 at Level 0, the downsampled version of the image at Level 5 of the image pyramid may be of resolution 20×15. In some embodiments, first frame 230, and second frame 240 may further be blurred to obtain downsampled and blurred first frame and downsampled and blurred second frame, respectively. For example, blurring may be accomplished by applying a 3×3 Gaussian filter to the images.

In step 325, a 2D displacement between downsampled and blurred first frame and downsampled and blurred second frame (which may be obtained from corresponding first frame 230, and second frame 240, respectively, may be computed so as to maximize the Normalized Cross-Correlation (NCC) between the image pair. NCC is a correlation based method that permits the matching on image pairs even in situations with large relative camera motion.

In some embodiments, in step 330, if the NCC value is not below some predetermined threshold (“Y” in step 330), then a 2D translation pose update 332 may be computed. In some embodiments, the threshold in step 300 may be computed and/or adjusted dynamically based on system parameters. In some embodiments, 2D translation pose update 332 may comprise an (x, y) displacement between the image pair. On the other hand, if the NCC value is below the threshold (“N” in step 330), then, predicted pose 220 may be output.

Additional steps in method 300 are shown in FIG. 3B. In FIG. 3B, in step 340, a plane induced homography may be computed using plane equation 260, and one of 2D Translation Pose Update 332, predicted pose 220 or pose update 353. In some embodiments, plane equation 260 may represent the plane equation for the dominant plane. A homography is an invertible transformation from a projective space to itself that maps straight lines to straight lines. Any two images of a planar surface in space are related by a homography. When more than one view is available, the transformation between imaged planes reduces to a 2D to 2D transformation and is termed plane induced homography.

In some embodiments, in step 335, a Jacobian 337 representing a matrix of all first-order partial derivatives of the plane induced homography function with respect to pose may be derived from plane equation 260.

In some embodiments, plane-induced homography may be computed using SE(3) parameterization. In general, the notation SE(n) refers to a Special Euclidean Group, which are isometries preserving orientation also called rigid motions. Isometries are distance-preserving mappings between metric spaces. For example, given a method for assigning distances between elements in a set in a metric space, an isometry is a mapping of the elements to another metric space where the distance between any pair of elements in the new metric space is equal to the distance between the pair in the original metric space. Rigid motions include translations and rotations, which together determine n. The number of Degrees Of Freedom (DoF) for SE(n) in given by n(n+1)/2, so that there are 3 DoF for SE(2) and 6 DoF for SE(3).

In the camera coordinate system of the template image T, the projection matrix has a trivial form of [I|0]. In addition, the plane equation may written as

n^{T}X=d. (5)

where n^{T} is the transpose of n (and the superscript ^{T} indicates the transpose) so that

$$\frac{1}{d} {n}^{T} X = 1 \qquad ( 6 )$$

Any relative pose update [R|t] induces a homography of the form

$${\tilde{u}}_{i} = R λ {\tilde{u}}_{t} + t = λ ( R + \frac{1}{d} t {n}^{T} ) {\tilde{u}}_{t} \qquad ( 7 )$$

where ũₜ is the homogeneous coordinate of a point in the template image, in the normalized sensor plane, and ũᵢ is the homogeneous coordinate of the corresponding point, with ũ=[u^{T},1]=[u,v,1]^{T}. X=λũᵢ and λ is the projective depth. That is the homography is given by

$${H}_{t 2 i} = R + \frac{1}{d} t \cdot {n}^{T} \qquad ( 8 )$$

which maps a point in the template image T to the observed image I as

ũᵢ≈Hₜ₂ᵢ·ũₜ (9)

and ≈ means equal up to a scale.

Further, using the matrix inversion lemma, or Woodbury matrix identity,

(A+UCV)⁻¹=A⁻¹−A⁻¹U(C⁻¹+VA⁻¹U)⁻¹VA⁻¹ (10)

the inverse homography may be written as

$$\begin{matrix}{H}_{t 2 i} = {R}^{T} - \frac{{R}^{T} {tn}^{T} {R}^{T}}{d + {n}^{T} {R}^{T} t} \\ or , & ( 11 ) \\ {H}_{i 2 t} = ( d + {n}^{T} {R}^{T} t ) {R}^{T} - {R}^{T} {tn}^{T} {R}^{T} & ( 12 )\end{matrix}$$

which may be rewritten using a first order approximation as,

$$\begin{matrix}{H}_{i 2 t} = d ( I + {Ω}^{T} ) + {n}^{T} t I - t {n}^{T} + O ( {θ}^{2} ) & ( 13 ) \\ {H}_{i 2 t} \approx ( d + {n}^{T} t ) I + d {Ω}^{T} - t {n}^{T} \\ where & ( 14 ) \\ Ω = [ \begin{matrix}0 & - {ω}_{z} & {ω}_{y} \\ {ω}_{z} & 0 & - {ω}_{x} \\ - {ω}_{y} & {ω}_{x} & 0\end{matrix} ] & ( 15 )\end{matrix}$$

which yields,

$$[ \begin{matrix}{u}_{i} \\ {v}_{i} \\ 1\end{matrix} ] ≅ [ \begin{matrix}( d + {n}^{T} t ) {u}_{t} + d ( {ω}_{z} {v}_{t} - {ω}_{y} ) - ( {n}^{T} {\tilde{u}}_{t} ) {t}_{x} \\ ( d + {n}^{T} t ) {v}_{t} + d ( - {ω}_{z} {u}_{t} + {ω}_{x} ) - ( {n}^{T} {\tilde{u}}_{t} ) {t}_{y} \\ ( d + {n}^{T} t ) + d ( {ω}_{y} {u}_{t} - {ω}_{x} {v}_{t} ) - ( {n}^{T} {\tilde{u}}_{t} ) {t}_{z}\end{matrix} ] \qquad ( 16 )$$

### That is

$$\begin{matrix}{u}_{i} \approx \frac{( d + {n}^{T} t ) {u}_{t} + d ( {ω}_{z} {v}_{t} - {ω}_{y} ) - ( {n}^{T} {\tilde{u}}_{t} ) {t}_{x}}{( d + {n}^{T} t ) + d ( {ω}_{y} {u}_{t} - {ω}_{x} {v}_{t} ) - ( {n}^{T} {\tilde{u}}_{t} ) {t}_{z}} & ( 17 ) \\ {v}_{i} \approx \frac{( d + {n}^{T} t ) {v}_{t} + d ( {ω}_{x} - {ω}_{z} {u}_{t} ) - ( {n}^{T} {\tilde{u}}_{t} ) {t}_{y}}{( d + {n}^{T} t ) + d ( {ω}_{y} {u}_{t} - {ω}_{x} {v}_{t} ) - ( {n}^{T} {\tilde{u}}_{t} ) {t}_{z}} & ( 18 )\end{matrix}$$

So the corresponding partial derivatives evaluated at θ=0 may be written as

$$\{ \begin{matrix}\frac{\partial {u}_{i}}{\partial {ω}_{x}} \approx {u}_{t} {v}_{t} , & \frac{\partial {u}_{i}}{\partial {ω}_{y}} \approx - ( 1 + {u}_{t}^{2} ) , & \frac{\partial {u}_{i}}{\partial {ω}_{z}} \approx {v}_{t} \\ \frac{\partial {u}_{i}}{\partial {t}_{x}} \approx - \frac{{n}^{T} {\tilde{u}}_{t}}{d} , & \frac{\partial {u}_{i}}{\partial {t}_{y}} \approx 0 , & \frac{\partial {u}_{i}}{\partial {t}_{z}} \approx {u}_{t} \frac{{n}^{T} {\tilde{u}}_{t}}{d} \\ \frac{\partial {v}_{i}}{\partial {ω}_{x}} \approx 1 + {v}_{t}^{2} , & \frac{\partial {v}_{i}}{\partial {ω}_{y}} \approx - {u}_{t} {v}_{t} , & \frac{\partial {v}_{i}}{\partial {ω}_{z}} \approx - {u}_{t} \\ \frac{\partial {v}_{i}}{\partial {t}_{x}} \approx 0 , & \frac{\partial {v}_{i}}{\partial {t}_{y}} \approx - \frac{{n}^{T} {\tilde{u}}_{t}}{d} , & \frac{\partial {v}_{i}}{\partial {t}_{z}} \approx {v}_{t} \frac{{n}^{T} {\tilde{u}}_{t}}{d}\end{matrix} \qquad ( 19 )$$

In some embodiments, equation (19) may be used to compute partial derivatives of image coordinates (u, v) with respect to SE(3) parameters, in the case of planar scenes, by using plane induced homography.

Note that a correspondence between Equation (1) given by Σₓ[T(W(x;Δp))−I(W(x;Δp))]² and Equation (19) can be derived by setting

x=[uₜvₜ]T (20)

p=[ωₓω_{y}ω_{z}tₓt_{y}t_{z}] (21)

W(x;Δp)=[uᵢvᵢ1]^{T} (22)

where [uᵢ vᵢ 1]^{T} is given by Equation (16) and

$$\begin{matrix}\frac{d W ( x ; Δ p )}{d p} = [ \frac{d {u}_{i}}{d p} ; \frac{d {v}_{i}}{d p} ] \\ = \{ \begin{matrix}\frac{\partial {u}_{i}}{\partial {ω}_{x}} \approx {u}_{t} {v}_{t} , & \frac{\partial {u}_{i}}{\partial {ω}_{y}} \approx - ( 1 + {u}_{t}^{2} ) , & \frac{\partial {u}_{i}}{\partial {ω}_{z}} \approx {v}_{t} \\ \frac{\partial {u}_{i}}{\partial {t}_{x}} \approx - \frac{{n}^{T} {\tilde{u}}_{t}}{d} , & \frac{\partial {u}_{i}}{\partial {t}_{y}} \approx 0 , & \frac{\partial {u}_{i}}{\partial {t}_{z}} \approx {u}_{t} \frac{{n}^{T} {\tilde{u}}_{t}}{d} \\ \frac{\partial {v}_{i}}{\partial {ω}_{x}} \approx 1 + {v}_{t}^{2} , & \frac{\partial {v}_{i}}{\partial {ω}_{y}} \approx - {u}_{t} {v}_{t} , & \frac{\partial {v}_{i}}{\partial {ω}_{z}} \approx - {u}_{t} \\ \frac{\partial {v}_{i}}{\partial {t}_{x}} \approx 0 , & \frac{\partial {v}_{i}}{\partial {t}_{y}} \approx - \frac{{n}^{T} {\tilde{u}}_{t}}{d} , & \frac{\partial {v}_{i}}{\partial {t}_{z}} \approx {v}_{t} \frac{{n}^{T} {\tilde{u}}_{t}}{d}\end{matrix}\end{matrix} \qquad ( 23 )$$

In some embodiments, Jacobian 337 may be represented by Equation (23).

In some embodiments, Jacobian 337 and homography matrix 343 may be input to an efficient iterative Lucas-Kanade or an equivalent method. In some embodiments, an Inverse Compositional Image Alignment technique, which is functionally equivalent to the Lucas-Kanade algorithm but more efficient computationally, may be used to determine the incremental pose update, in step 345, which is given by equation (24) below.

$$Δ p = {H}^{- 1} {\sum }_{x} {[ ∇ T \frac{\partial W}{\partial p} ]}^{T} [ I ( W ( x ; p ) ) - T ( x ) ] \qquad ( 24 )$$

where H is a Hessian square matrix of second-order partial derivatives and approximated by

$${\sum }_{x} {[ ∇ T \frac{\partial W}{\partial p} ]}^{T} [ ∇ T \frac{\partial W}{\partial p} ]$$

The optimization is conducted at one or more higher resolution levels of the image pyramid than was used for NCC. For example, if images of 20×15 resolution from the image pyramid were used for NCC (in step 325), then images of 40×30 resolution may be used next.

In step 350, a test for convergence may be applied to the Lucas-Kanade or equivalent method. If the method in step 345 has not converged (“N” in step 350), then the method returns to step 340 to begin another iteration using the plane induced homography computed from the updated pose 353. In some embodiments, convergence in step 340 may be determined based on the magnitude of a pixel displacement between the images computed in step 345.

If the method in step 345 has converged or reached a maximum number of iterations (“Y” in step 350), then, the method proceeds to step 355. In step 355, if the Lucas-Kanade or equivalent method has converged (“Y” in step 355) then final image alignment pose 270 may be output. Otherwise (“N” in step 355), predicted pose 220 may be output.

In step 360, feature tracking may be initialized using either final image alignment pose 270 or predicted pose 220. In some embodiments, the feature tracker may use either final image alignment pose 270 or predicted pose 220 to compute final feature tracker pose 290. In some embodiments, the feature tracker is provided with a model of an object in the form of 2D/3D corners and edges. The feature tracker tracks the object by searching in captured video frames for the corresponding edges and/or corners. The starting position of the search is determined from the final image alignment pose 270 or predicted pose 220. From the correspondences determined by the feature tracker, the final feature tracker pose 290 may be computed.

If feature tracking is successful (“Y” in step 365), then final feature tracker pose 290 may be output and in step 390, the augmentation may be rendered. In some embodiments, final feature tracker pose 290 may be used as input by motion predictor 305.

If feature tracking step 365 fails (“N” in step 365), then, in step 370, the method checks whether image alignment had previously failed (i.e. “N”) in step 355. In step 370, if image alignment in step 355 has previously failed, then, the method proceeds to step 380.

In step 370, if it is determined that image alignment step 355 was successful, then, in step 375, the method may determine if execution reached step 375 for C consecutive frames. If step 375 was invoked for C consecutive frames (“Y” in step 375) then the method proceeds to step 380.

In step 380, an Error message indicating tracking failure may be displayed, relocalization may be attempted, and/or other corrective techniques may be employed.

If step 375 was not invoked for C consecutive frames (“N” in step 375), then, in some embodiments, final image alignment pose 270 may be used to render the augmentation in step 390—despite the failure of the feature tracker. The convergence of the Lucas Kanade or equivalent method (such as Inverse Compositional Image Alignment) in step 345 is indicative of a successful minimization of the sum of the squared intensity differences of the two consecutive images. A low value for the sum of the squared intensity differences is indicative of the images being spatially close and may be also indicate that the failure of feature tracker (“N” in step 365) is transient. Therefore, in some embodiments, in step 390, the augmentation may be rendered using final image alignment pose 270. In some embodiments, following step 390, final image alignment pose 270 may also be used to initialize motion predictor 305.

In some embodiments, portions of method 300 may be performed by some combination of UD 100, and one or more servers or other computers wirelessly coupled to UD 100 through transceiver 170. For example, UD may send data to a server and one or more steps in method 300 may be performed by a server and the results may be returned to UD 100.

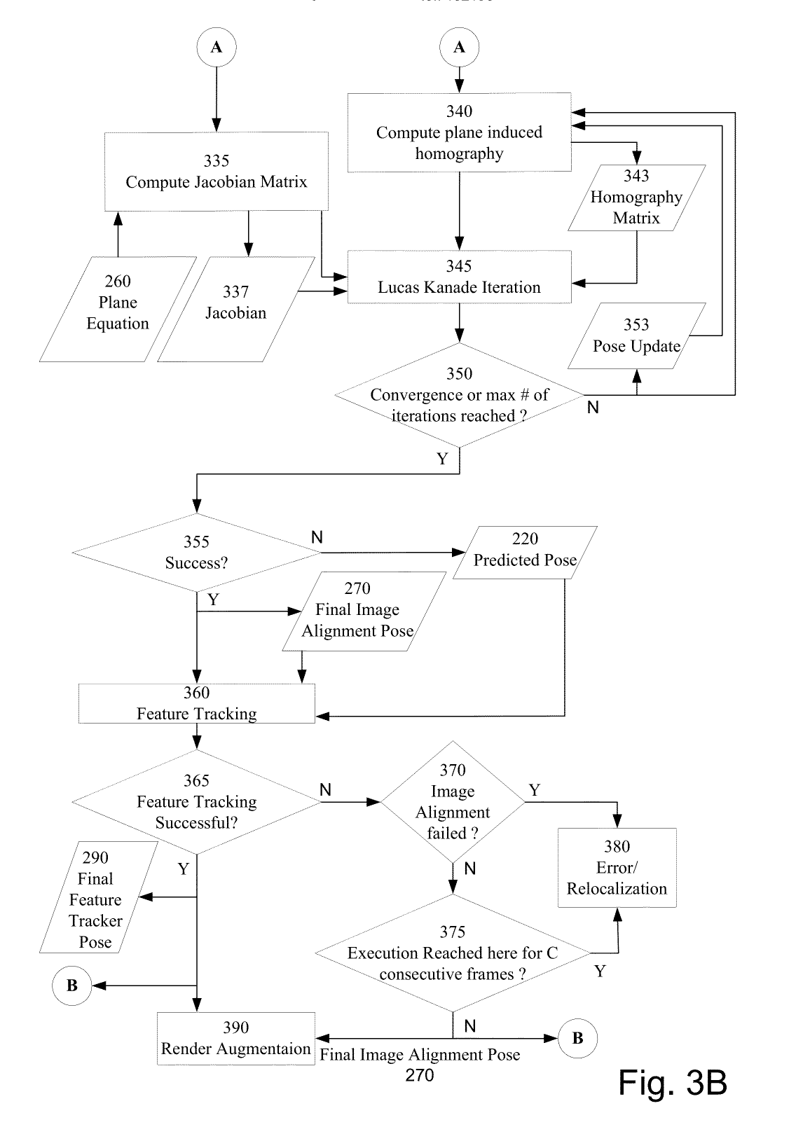

FIG. 4 shows a flowchart for one iteration of an exemplary method 400 for feature based tracking in a manner consistent with disclosed embodiments.

In some embodiments, in step 410, a camera pose relative to a tracked object in a first image may be obtained. In some embodiments, the camera pose may be obtained based on previously computed final feature tracker pose 290 for first frame 230, which may be an immediately preceding frame.

Next, in step 420, a predicted camera pose relative to the tracked object for a second image subsequent to the first image may be determined based on a motion model of the tracked object. For example, predicted camera pose 220 may be determined for current image 240 using motion model 210.

In step 430, an updated Special Euclidean Group (3) (SE(3)) camera pose may be obtained. The updated SE(3) pose may be obtained based, in part, on the predicted pose 220, by estimating a plane induced homography using an equation of a dominant plane of the tracked object, wherein the plane induced homography is used to align a first lower resolution version of the first image and a first lower resolution version of the second image by minimizing the sum of the squared intensity differences of the first lower resolution version of the first image and the first lower resolution version of the second image. In some embodiments, the minimization of the sum of the squared intensity differences of the first lower resolution version of the first image and the first lower resolution version of the second image may be performed using an Inverse Compositional Image Alignment technique. In some embodiments, the equation of the dominant plane in the first image may be obtained based on a 3-dimensional (3D) model of the tracked object.

In some embodiments, the SE(3) camera pose update computed in step 430 may be used to initialize a feature tracker, wherein the feature tracker may determine a feature tracker camera pose based, in part, on the updated SE(3) pose. In some embodiments, the feature tracker camera pose may be used to determine an initial camera pose for a third image subsequent and consecutive to the second image. In some embodiments, an Augmented Reality (AR) image may be rendered based, in part, on the feature tracker camera pose.

In some embodiments, in step 420, the predicted camera pose may be determined based, in part, on the motion model by refining a motion model determined camera pose relative to the tracked object in the second image. For example, the fronto-parallel translation motion using Normalized Cross Correlation (NCC) between a second lower resolution version of the first image and a second lower resolution version of the second image may be estimated and the estimated fronto-parallel translation motion may be used to determined the predicted camera pose.

In some embodiments, the first and second images may be associated with respective first and second image pyramids and the first lower resolution version of the first image and the first lower resolution version of the second image form part of the first and second image pyramids, respectively.

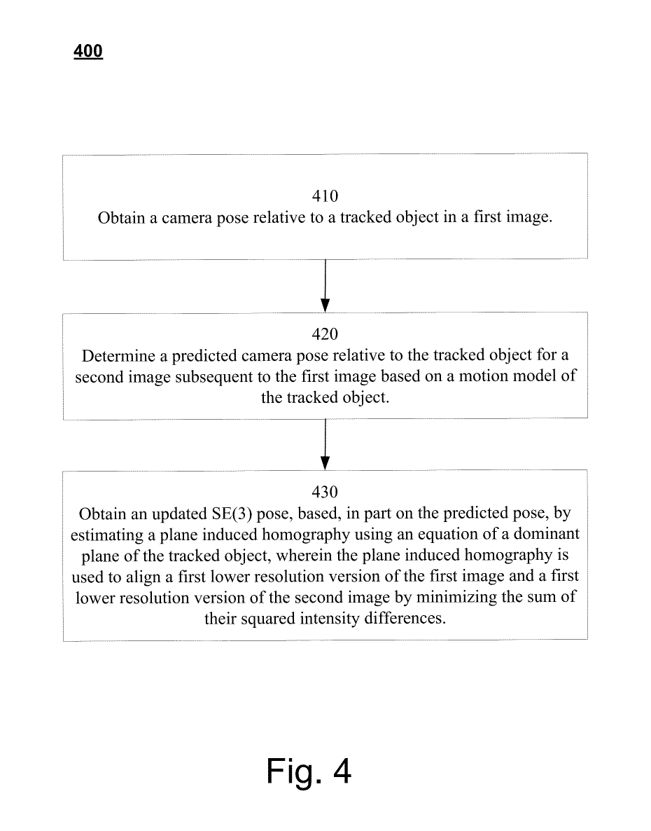

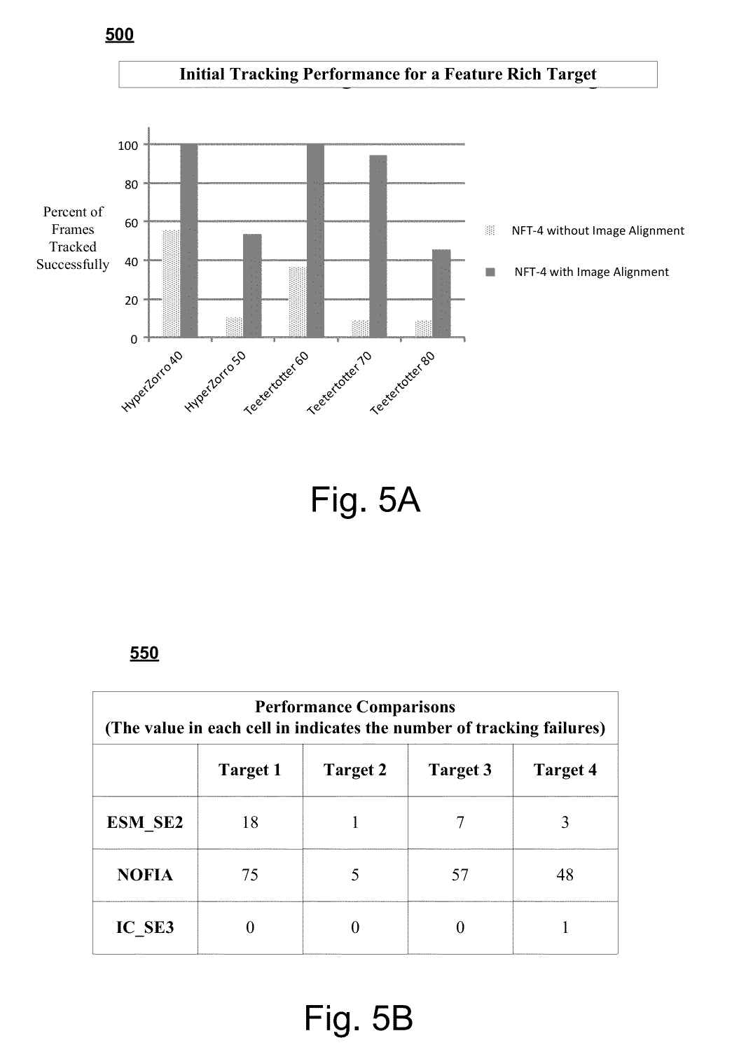

FIG. 5A shows a chart 500 illustrating the initial tracking performance for a feature rich target with both point and line features for two Natural Features Tracking (NFT) methods shown as NFT-4 without image alignment and NFT4 with image alignment. NFT-4 with image alignment is one implementation of a method consistent with disclosed embodiments. The Y-axis indicates the percentage of frames successfully tracked. The X-axis shows various movements of the camera used for tracking. In the “HyperZorro” series of movements, camera “draws” slanted Figure “8” on a slanted plane. In the “Teetertotter” series of movements, the camera bounces up and down while moving from left to right and back. The numbers following HyperZorro and Teetertotter provide an indication of how quickly a robot arm executed the motion. A higher number indicates faster movement. As shown in FIG. 5A, NFT-4 with Image Alignment consistently outperforms NFT-4 without image alignment.

FIG. 5B shows Table 550 with Performance Comparisons showing Tracking results for four different target types. In Table 550, the row labeled IC_SE3 represents one implementation of a method consistent with embodiments disclosed herein. The row labeled “NOFIA” represents a conventional method with fast image alignment. The row labeled ESM_SE2 represents another method known in the art using a keyframe based SLAM algorithm that performs image alignment in SE(2) using Efficient Second order Minimization (ESM). The entries for cell in Table 550 indicate the number of tracking failures in a sequence of nine hundred consecutive image frames. Targets 1-4 are feature rich targets with a lot of line features. As shown in FIG. 5B, IC_SE3 exhibited almost no tracking failures over the image sequence. Specifically, the implementation IC_SE3 outperformed other methods in sequences with significant zooming motion and/or where the target was viewed from a very oblique angle.

Embodiments disclosed herein facilitate accurate and robust tracking for a variety of targets, including 3D and planar targets and permit tracking with 6-DoF. Disclosed embodiments facilitate tracking in the presence of motion blur, in situations with fast camera acceleration and in instances with oblique camera angles thereby improving tracking robustness. The methodologies described herein may be implemented by various means depending upon the application. For example, for a firmware and/or software implementation, the methodologies may be implemented with procedures, functions, and so on that perform the functions described herein. Any machine-readable medium tangibly embodying instructions may be used in implementing the methodologies described herein. For example, software code may be stored in memory 160 and executed by processor(s) 150 on UD 100. In some embodiments, the functions may be stored as one or more instructions or code on a computer-readable medium on MSA 100. Examples include computer-readable media encoded with a data structure and computer-readable media encoded with a computer program. Computer-readable media includes physical computer storage media.

A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus coupled to UD 100. For example, a communication apparatus may include transceiver 170 having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Reference is now made to FIG. 6, which is a schematic block diagram illustrating a computing device 600 enabled to facilitate feature based tracking in a manner consistent with disclosed embodiments. In some embodiments, computing device 600 may take the form of a server. In some embodiments, the server may be in communication with a UD 100. In some embodiments, computing device 600 may perform portions of the methods 200, 300 and/or 400. In some embodiments, methods 200, 300 and/or 400 may be performed by processor(s) 650 and/or Computer Vision module 655. For example, the above methods may be performed in whole or in part by processor(s) 650 and/or Computer Vision Module 655 in conjunction with one or more functional units on computing device 600 and/or in conjunction with UD 100. For example, computing device 500 may receive a sequence of captured images including first frame 230 and second frame 240 from a camera 110 coupled to UD 100 and may perform methods 200, 300 and/or 400 in whole, or in part, using processor(s) 650 and/or Computer Vision module 655.

In some embodiments, computing device 600 may be wirelessly coupled to one or more UD's 100 over a wireless network (not shown), which may one of a WWAN, WLAN or WPAN. In some embodiments, computing device 500 may include, for example, one or more processor(s) 650, memory 660, storage 610, and (as applicable) communications interface 630 (e.g., wireline or wireless network interface), which may be operatively coupled with one or more connections 620 (e.g., buses, lines, fibers, links, etc.). In certain example implementations, some portion of computing device 600 may take the form of a chipset, and/or the like.

Communications interface 630 may include a variety of wired and wireless connections that support wired transmission and/or reception and, if desired, may additionally or alternatively support transmission and reception of one or more signals over one or more types of wireless communication networks. Communications interface 630 may include interfaces for communication with UD 100 and/or various other computers and peripherals. For example, in one embodiment, communications interface 630 may comprise network interface cards, input-output cards, chips and/or ASICs that implement one or more of the communication functions performed by computing device 600. In some embodiments, communications interface 630 may also interface with UD 100 to send 3D model information for an environment, and/or receive data and/or instructions related to methods 200, 300 and/or 400.

Processor(s) 650 may use some or all of the received information to perform the requested computations and/or to send the requested information and/or results to UD 100 via communications interface 630. In some embodiments, processor(s) 650 may be implemented using a combination of hardware, firmware, and software. In some embodiments, processing unit 552 may include Computer Vision (CV) Module 566, which may generate and/or process 3D models of the environment, perform 3D reconstruction, implement and execute various computer vision methods including methods 200, 300 and/or 400. In some embodiments, processor(s) 650 may represent one or more circuits configurable to perform at least a portion of a data signal computing procedure or process related to the operation of computing device 600.

The methodologies described herein in flow charts and message flows may be implemented by various means depending upon the application. For example, these methodologies may be implemented in hardware, firmware, software, or any combination thereof. For a hardware implementation, the processors 650 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with procedures, functions, and so on that perform the functions described herein. Any machine-readable medium tangibly embodying instructions may be used in implementing the methodologies described herein. For example, software may be stored in removable media drive 640, which may support the use of computer-readable media 645, including removable media. Program code may be resident on non-transitory computer readable media 645 and/or memory 660 and may be read and executed by processor(s) 650. Memory 660 may be implemented within processor(s) 650 or external to the processor(s) 650. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium 645 and/or on memory 660. Examples include computer-readable media encoded with a data structure and computer-readable media encoded with a computer program. For example, computer-readable medium 645 including program code stored thereon may include program code to facilitate computer vision methods such as feature based tracking, image alignment, and/or one or more of methods 200, 300 and/or 400, in a manner consistent with disclosed embodiments.

Non-transitory computer-readable media may include a variety of physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Other embodiments of non-transitory computer readable media include flash drives, USB drives, solid state drives, memory cards, etc. Combinations of the above should also be included within the scope of computer-readable media.

In addition to storage on computer readable medium, instructions and/or data may be provided as signals on transmission media to communications interface 630, which may store the instructions/data in memory 660, storage 610 and/or relayed the instructions/data to processor(s) 650 for execution. For example, communications interface 630 may receive wireless or network signals indicative of instructions and data. The instructions and data are configured to cause one or more processors to implement the functions outlined in the claims. That is, the communication apparatus includes transmission media with signals indicative of information to perform disclosed functions.

Memory 660 may represent any data storage mechanism. Memory 660 may include, for example, a primary memory and/or a secondary memory. Primary memory may include, for example, a random access memory, read only memory, non-volatile RAM, etc. While illustrated in this example as being separate from processor(s) 650, it should be understood that all or part of a primary memory may be provided within or otherwise co-located/coupled with processor(s) 650. Secondary memory may include, for example, the same or similar type of memory as primary memory and/or storage 610 such as one or more data storage devices 610 including, for example, hard disk drives, optical disc drives, tape drives, a solid state memory drive, etc.

In some embodiments, storage 610 may comprise one or more databases that may hold information pertaining to an environment, including 3D models, keyframes, information pertaining to virtual objects, etc. In some embodiments, information in the databases may be read, used and/or updated by processor(s) 650 during various computations.

In certain implementations, secondary memory may be operatively receptive of, or otherwise configurable to couple to a non-transitory computer-readable medium 645. As such, in certain example implementations, the methods and/or apparatuses presented herein may be implemented in whole or in part using non-transitory computer readable medium 645 that may include with computer implementable instructions stored thereon, which if executed by at least one processor(s) 650 may be operatively enabled to perform all or portions of the example operations as described herein. In some embodiments, computer readable medium 645 may be read using removable media drive 640 and/or may form part of memory 660.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method comprising:
obtaining a camera pose relative to a tracked object in a first image;
determining a predicted camera pose relative to the tracked object for a second image subsequent to the first image based, in part, on a motion model of the tracked object; and
obtaining an updated Special Euclidean Group (3) (SE(3)) camera pose, based, in part on the predicted camera pose, by estimating a plane induced homography using an equation of a dominant plane of the tracked object, wherein the plane induced homography is used to align a first lower resolution version of the first image and a first lower resolution version of the second image by minimizing the sum of the squared intensity differences of the first lower resolution version of the first image and the first lower resolution version of the second image.

2. The method of claim 1, further comprising:
initializing a feature tracker with the updated SE(3) camera pose, wherein the feature tracker determines a feature tracker camera pose based, in part, on the updated SE(3) pose.

3. The method of claim 1, wherein the equation of the dominant plane in the first image is obtained based on a 3-dimensional (3D) model of the tracked object.

4. The method of claim 1, wherein the minimization of the sum of the squared intensity differences of the first lower resolution version of the first image and the first lower resolution version of the second image is performed using an Inverse Compositional Image Alignment technique.

5. The method of claim 1, wherein determining the predicted camera pose based, in part, on the motion model comprises:
refining a motion model determined camera pose relative to the tracked object in the second image by estimating fronto-parallel translation motion using Normalized Cross Correlation (NCC) between a second lower resolution version of the first image and a second lower resolution version of the second image, wherein the estimated fronto-parallel translation motion is used to determined the predicted camera pose.

6. The method of claim 5, wherein the second lower resolution version of the first image and the second lower resolution version of the second image are blurred prior to NCC.

7. The method of claim 6, wherein the first and second images are associated with respective first and second image pyramids and the first lower resolution version of the first image and the first lower resolution version of the second image form part of the first and second image pyramids, respectively.

8. The method of claim 2, further comprising:
determining an initial camera pose for a third image subsequent and consecutive to the second image based, in part, on the feature tracker camera pose.

9. The method of claim 2, further comprising:
rendering an Augmented Reality (AR) image based, in part, on the feature tracker camera pose.

10. A User Device (UD) comprising:
a camera, the camera to capture a first image and a second image subsequent to the first image, and
a processor coupled to the camera, the processor configured to:
obtain a camera pose relative to a tracked object in the first image,
determine a predicted camera pose relative to the tracked object for the second image based, in part, on a motion model of the tracked object, and
obtain an updated Special Euclidean Group (3) (SE(3)) camera pose, based, in part on the predicted camera pose, by estimating a plane induced homography using an equation of a dominant plane of the tracked object, wherein the plane induced homography is used to align a first lower resolution version of the first image and a first lower resolution version of the second image by minimizing the sum of the squared intensity differences of the first lower resolution version of the first image and the first lower resolution version of the second image.

11. The UD of claim 10, wherein the processor is further configured to:
initialize a feature tracker with the updated SE(3) camera pose, wherein the feature tracker determines a feature tracker camera pose based, in part, on the updated SE(3) camera pose.

12. The UD of claim 10, wherein the processor obtains the equation of the dominant plane in the first image based on a 3-dimensional (3D) model of the tracked object.

13. The UD of claim 10, wherein the minimization of the sum of the squared intensity differences of the first lower resolution version of the first image and the first lower resolution version of the second image is performed using an Inverse Compositional Image Alignment technique.

14. The UD of claim 13, wherein to determine the predicted camera pose based, in part, on the motion model, the processor is further configured to:
refine a motion model determined camera pose relative to the tracked object in the second image by a estimating fronto-parallel translation motion using Normalized Cross Correlation (NCC) between a second lower resolution version of the first image and a second lower resolution version of the second image, and wherein the estimated fronto-parallel translation motion is used to determine the predicted camera pose.

15. The UD of claim 14, wherein the processor is further configured to blur the second lower resolution version of the first image and the second lower resolution version of the second image prior to NCC.

16. The UD of claim 14, wherein the first and second images are associated with respective first and second image pyramids and the first and second lower resolution versions of the first and second images form part of the first and second image pyramids, respectively.

17. The UD of claim 11, wherein the processor is further configured to:
determine an initial camera pose for a third image subsequent and consecutive to the second image based, in part, on the feature tracker camera pose.

18. The UD of claim 11, further comprising:
a display coupled to the processor, wherein the processor is further configured to:
render an Augmented Reality (AR) image on the display using the feature tracker camera pose.

19. An apparatus comprising:
imaging means, the imaging means to capture a first image and a second image subsequent to the first image,
means for obtaining a imaging means pose relative to a tracked object in the first image;
means for determining a predicted imaging means pose relative to the tracked object for the second image based, in part, on a motion model of the tracked object; and
means for obtaining an updated Special Euclidean Group (3) (SE(3)) imaging means pose, based, in part on the predicted imaging means pose, by estimating a plane induced homography using an equation of a dominant plane of the tracked object, wherein the plane induced homography is used to align a first lower resolution version of the first image and a first lower resolution version of the second image by minimizing the sum of the squared intensity differences of the first lower resolution version of the first image and the first lower resolution version of the second image.

20. The apparatus of claim 19, further comprising:
means for initializing a feature tracker with the updated SE(3) imaging means pose, wherein the feature tracker comprises:
means for determining a feature tracker imaging means pose based, in part, on the updated SE(3) imaging means pose.

21. The apparatus of claim 19, wherein the minimization of the sum of the squared intensity differences of the first lower resolution version of the first image and the first lower resolution version of the second image is performed using an Inverse Compositional Image Alignment technique.

22. The apparatus of claim 19, wherein means for determining the predicted imaging means pose based, in part, on the motion model, further comprises:
means for refining a motion model determined imaging means pose relative to the tracked object in the second image by a estimating fronto-parallel translation motion using Normalized Cross Correlation (NCC) between a second lower resolution version of the first image and a second lower resolution version of the second image, and wherein the estimated fronto-parallel translation motion is used by means for determining the predicted imaging means pose.

23. The apparatus of claim 20, further comprising:
means for rendering an Augmented Reality (AR) image on the display using the feature tracker imaging means pose.

24. A non-transitory computer-readable medium comprising instructions, which, when executed by a processor, perform steps in a method, the steps comprising:
obtaining a camera pose relative to a tracked object in a first image;
determining a predicted camera pose relative to the tracked object for a second image subsequent to the first image based, in part, on a motion model of the tracked object; and
obtaining an updated Special Euclidean Group (3) (SE(3)) camera pose, based, in part on the predicted camera pose, by estimating a plane induced homography using an equation of a dominant plane of the tracked object, wherein the plane induced homography is used to align a first lower resolution version of the first image and a first lower resolution version of the second image by minimizing the sum of the squared intensity differences of the first lower resolution version of the first image and the first lower resolution version of the second image.

25. The computer-readable medium of claim 24, the steps further comprising:
initializing a feature tracker with the updated SE(3) camera pose, wherein the feature tracker determines a feature tracker camera pose based, in part, on the updated SE(3) pose.

26. The computer-readable medium of claim 24, wherein the equation of the dominant plane in the first image is obtained based on a 3-dimensional (3D) model of the tracked object.

27. The computer-readable medium of claim 24, wherein the minimization of the sum of the squared intensity differences of the first lower resolution version of the first image and the first lower resolution version of the second image is performed using an Inverse Compositional Image Alignment technique.

28. The computer-readable medium of claim 24, wherein the predicted camera pose based, in part, on the motion model is obtained by:
refining a motion model determined camera pose relative to the tracked object in the second image by estimating fronto-parallel translation motion using Normalized Cross Correlation (NCC) between a second lower resolution version of the first image and a second lower resolution version of the second image, wherein the estimated fronto-parallel translation motion is used to determined the predicted camera pose.

29. The computer-readable medium of claim 25, the steps further comprising:
determining an initial camera pose for a third image subsequent and consecutive to the second image based, in part, on the feature tracker camera pose.

30. The computer-readable medium of claim 25, the steps further comprising:
rendering an Augmented Reality (AR) image based, in part, on the feature tracker camera pose.
